(19) United States
(12) Patent Application Publication
(10) Pub. No.: US 2017/0064185 A1
(43) Pub. Date: Mar. 2, 2017

(54) METHOD OF ESTIMATING PHASE DIFFERENCE, APPARATUS, AND STORAGE MEDIUM

(71) Applicant: FUJITSU LIMITED, Kawasaki-shi (JP)

(72) Inventors: Megumi CHIKANO, Kawasaki (JP); Shohei NAKAGATA, Kawasaki (JP); RYUTA TANAKA, Machida (JP)

(73) Assignee: FUJITSU LIMITED, Kawasaki-shi (JP)

(21) Appl. No.: 15/209,220

(22) Filed: Jul. 13, 2016

(30) Foreign Application Priority Data
Sep. 1, 2015 (JP) 2015-172335

(51) Int. Cl. H04N 5/232; G02B 7/09

(52) U.S. Cl. CPC H04N 5/23212; G02B 7/09

(57) ABSTRACT

A method of estimating a phase difference includes: setting an area that is to be focused in an imaging range of an imaging device, the imaging device including an imaging element having a plurality of pixel arrays of phase-different pixels; first calculating, when a representative value for the plurality of pixel arrays is calculated, a pixel reference direction in which a pixel value is referred to, based on a position of an edge that appears in the plurality of pixel arrays; executing statistical processing of the pixel value for the plurality of pixel arrays in the calculated reference direction; and second calculating, by a processor, a phase difference using a pixel array that represents the plurality of pixel arrays that have been calculated by the statistical processing.

### CROSS-REFERENCE TO RELATED APPLICATION

This application is based upon and claims the benefit of priority of the prior Japanese Patent Application No. 2015-172335, filed on Sep. 1, 2015, the entire contents of which are incorporated herein by reference.

### FIELD

The embodiments discussed herein are related to a method of estimating a phase difference, an apparatus, and a storage medium.

### BACKGROUND

As an example of an autofocus (AF) technology in which the focus of an imaging device, such as a digital camera and the like, is automatically adjusted, a phase difference AF is known. In phase difference AF, in some of pixels included in an imaging element, a pair of pixels that has been inverted such that incident angle characteristics of light that enters respective light receiving elements of the pair of pixels are horizontally symmetrical or vertically symmetrical to one another is incorporated as phase-different pixels by processing that is performed on an optical system or the imaging device. Using the phase-different pixels that have been incorporated in the imaging element in the above-described manner, a defocus amount is calculated from a phase difference in a position in which an image of a subject is formed on a light receiving surface via a lens.

For example, as an example of technologies related to phase difference AF, an imaging device below has been proposed. An imaging device adds outputs of focus detection pixels of a first number, which are arranged in a perpendicular direction to a phase difference detection direction of an imaging element together to generate a first addition output, and executes a focus detection operation, based on the first addition output. Also, the imaging device adds outputs of focus detection pixels of a second number that is smaller than the first number together to generate a plurality of second addition outputs in the phase difference detection direction and the perpendicular direction. Then, the imaging device determines whether or not a rotational error is to be corrected, based on the plurality of second addition outputs and, if it is determined that a rotational error is to be corrected, the rotational error is corrected for a result of the focus detection operation.

As an example of related art, Japanese Laid-open Patent Publication No. 2014-137508 is known.

### SUMMARY

According to an aspect of the invention, a method of estimating a phase difference includes: setting an area that is to be focused in an imaging range of an imaging device, the imaging device including an imaging element having a plurality of pixel arrays of phase-different pixels; first calculating, when a representative value for the plurality of pixel arrays is calculated, a pixel reference direction in which a pixel value is referred to, based on a position of an edge that appears in the plurality of pixel arrays; executing statistical processing of the pixel value for the plurality of pixel arrays in the calculated reference direction; and second calculating, by a processor, a phase difference using a pixel array that represents the plurality of pixel arrays that have been calculated by the statistical processing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional configuration of an imaging device according to a first embodiment;

FIG. 2A is a view illustrating an example of arrangement of phase-different pixels;

FIG. 2B is a view illustrating another example of arrangement of phase-different pixels;

FIG. 3 is a view illustrating an example of focus;

FIG. 4 is a view illustrating an example of a phase difference;

FIG. 5 is a diagram illustrating an example of edge;

FIG. 6 is a graph illustrating an example of relationship between position and pixel value for a phase-different pixel;

FIG. 7 is a graph illustrating an example of relationship between position and pixel value for a phase-different pixel;

FIG. 8 is a graph illustrating an example of a result of SAD calculation;

FIG. 9 is a graph illustrating an example of a result of SAD calculation;

FIG. 10 is a diagram illustrating an example of edge detection;

FIG. 11 is a diagram illustrating an example of a correlation calculation method;

FIG. 12 is a diagram illustrating an example of statistical processing;

FIG. 13 is a diagram illustrating an example of a SAD calculation method;

FIG. 14 is a flow chart illustrating steps of phase difference AF processing according to the first embodiment;

FIG. 15 is a view illustrating an example of a distance measurement area dividing method;

FIG. 16 is a diagram illustrating an application example of the distance measurement area dividing method;

FIG. 17 is a diagram illustrating an application example of statistical processing; and

FIG. 18 is a diagram illustrating a hardware configuration example of a computer that executes a phase difference estimation program according to each of the first embodiment and a second embodiment.

### DESCRIPTION OF EMBODIMENTS

In the related art, there are cases where the accuracy of phase difference estimation is reduced.

That is, in the above-described imaging device, outputs of focus detection pixels are added together in order to obtain the first addition output only in a uniform direction, that is, a perpendicular direction to a phase difference detection direction. Therefore, in a case where an edge of an image which may be acquired as the first addition output has a gradient compared to the perpendicular direction, as a result of smoothing the edge by adding the outputs of focus detection pixels together in the perpendicular direction, the edge gradually becomes dull. When the edge becomes dull in the above-described manner, an error tends to occur in operation of correlation, such as the sum of absolute differences (SAD) and the like, which is used for estimation of a phase difference. As a result, there are cases where the accuracy of phase difference estimation is reduced.

In one aspect, according to an embodiment, reduction in accuracy of phase difference estimation may be reduced.

Embodiments of the present disclosure will be described below with reference to the accompanying drawings. Note that the disclosed technology is not limited to embodiments described below. Each of embodiments may be combined, as appropriate, to the extent that there is no contradiction.

### First Embodiment

### Configuration of Imaging Device 1

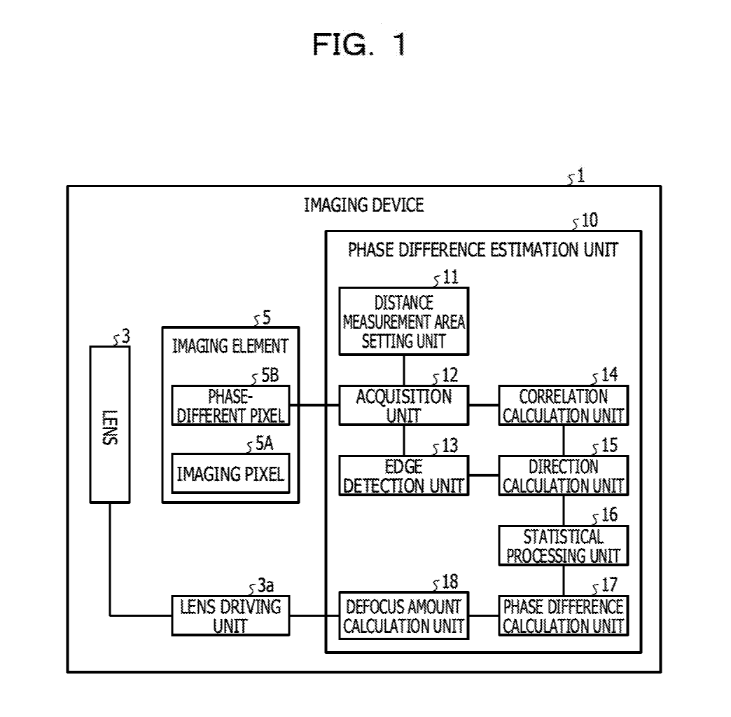

FIG. 1 is a diagram illustrating an example of a functional configuration of an imaging device 1 according to a first embodiment. The imaging device 1 illustrated in FIG. 1 executes phase difference AF processing in which a defocus amount is calculated from a phase difference in a position in which an image of a subject is formed on a light receiving surface via the lens 3, using phase-different pixels 5B incorporated in an imaging element 5. Note that, although a case where the imaging device 1 employs a mirrorless image surface phase difference AF method will be described below as an example, the case described below is merely an example, and the imaging device 1 may be similarly applied to a case where the imaging device 1 employs a with-mirror phase difference AF method in which light from the lens 3 is caused to enter an AF sensor including the phase-different pixels 5B by a mirror.

As illustrated in FIG. 1, the imaging device 1 includes the lens 3, a lens driving unit 3a, the imaging element 5, and a phase difference estimation unit 10. The imaging device 1 may include, in addition to the functional units illustrated in FIG. 1, various functional units used in a known imaging device. For example, the imaging device 1 may include, in addition to an input unit that receives various types of instruction inputs, such as, for example, an imaging instruction, a designation of an area which is to be focused, and the like, an output unit that outputs various types of information, such as, for example, a live view image with which a layout of an image that is formed by the imaging device 1 and the like may be checked, and the like.

The lens 3 is an optical element that collects light from a predetermined visual field area.

As an embodiment, the lens 3 is mounted as a focus adjusting lens included in an imaging optical system. In FIG. 1, a single lens is schematically illustrated as the lens 3, but, in an actual imaging optical system, a plurality of lenses is combined to function as a focus adjusting lens. The lens 3 that is incorporated in the imaging optical system in the above-described manner is driven in an optical axis direction of the lens 3, that is, in a front-and-rear direction, via the lens driving unit 3a.

The lens driving unit 3a is a mechanism that drives the lens 3.

As an embodiment, the lens driving unit 3a is mounted using a direct-current (DC) motor, a stepping motor, or the like. The lens driving unit 3a causes the lens 3 to move on an optical axis in accordance with an instruction from the phase difference estimation unit 10. Thus, for example, the lens driving unit 3a adjusts a focus position of the lens 3 and changes an angle of a view of an image that is formed by the imaging element 5.

The imaging element 5 is a semiconductor element that converts light that is collected by the lens 3 to an electrical signal.

As an embodiment, the imaging element 5 is mounted using a complementary metal oxide semiconductor (CMOS) in which a plurality of pixels is arranged in a matrix, and the like. In the imaging element 5, an imaging pixel 5A that is used as a pixel for use in imaging is incorporated and a pair of pixels that have been inverted such that incident angle characteristics of light that enters respective light receiving elements of the pair of pixels are horizontally symmetrical or vertically symmetrical to one another are incorporated as the phase-different pixels 5B in some of pixels included in the imaging element 5.

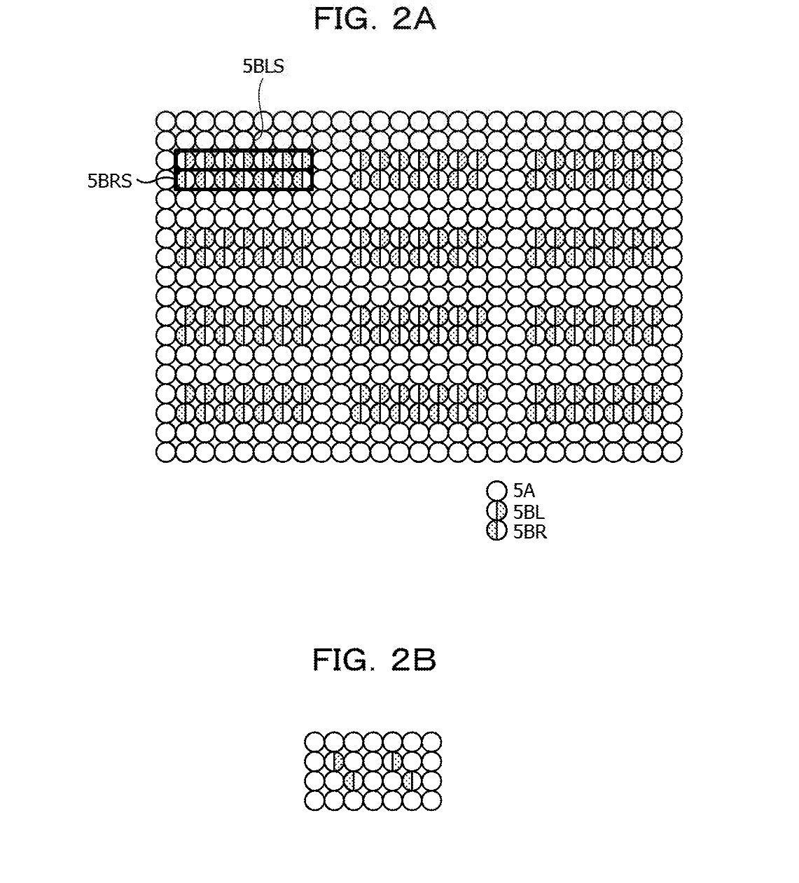

FIG. 2A is a view illustrating an example of arrangement of phase-different pixels 5B. As illustrated in FIG. 2A, left pixels 5BL into which a light flux enters from the light side of the lens 3 and right pixels 5BR into which a light flux enters from the right side of the lens 3 are incorporated in the phase-different pixels 5B. The left pixels 5BL and the right pixels 5BR are provided such that pixels of each type are arranged as a string in a phase difference detection direction, that is, in a row direction (the horizontal direction) in an example illustrated in FIG. 2A, and thereby are arranged in lines as left pixel allays 5BLS and right pixel arrays 5BRS, respectively. Furthermore, each of the left pixel allays 5BLS and the corresponding one of the right pixel arrays 5BRS are arranged as a pair in a state in which the left pixel allay 5BLS and the right pixel array 5BRS are located adjacent to one another in a perpendicular direction to the phase difference detection direction. With the phase-different pixels 5B arranged in the above-described manner, in phase difference AF processing, using each image that is read from a pair of the corresponding one of the left pixel allays 5BLS and the corresponding one of the right pixel arrays 5BRS, a phase difference in a position in which an image of a subject is formed to the left pixel array 5BLS and the right array 5BRS via the lens 3 is estimated. In the following description, occasionally, an image formed by a string of pixel values in the row direction, which have been read from the left pixels 5BL included in the left pixel array 5BLS, will be referred to as a “left image”, and an image formed by a string of pixel values in the row direction, which have been read from the right pixels 5BR included in the right pixel array 5BRS, will be referred to as a “right image”.

In the example of FIG. 2A, a case where the phase-different pixels 5B are closely arranged in the horizontal direction and the perpendicular direction is illustrated as an example, but the arrangement of the phase-different pixels 5B is not limited thereto. For example, the phase-different pixels 5B may be discretely arranged. Also, the phase-different pixels 5B may be arranged such that the respective positions of the left and right pixels in the horizontal direction are shifted from one another. FIG. 2B is a view illustrating another example of arrangement of phase-different pixels. As illustrated in FIG. 2B, there may be a case where the left pixels 5BL and the right pixels 5BR are not continuously arranged in the horizontal direction, that is, in the row direction, and each of the left pixel 5BL and the right pixel 5BR may be arranged in every third pixels. Also, even in a case where the phase-different pixels 5B are discretely arranged, the left pixels 5BL and the right pixels 5BR may be arranged in arbitrary intervals. Furthermore, there may be a case where the left pixels 5BL and the right pixels 5BR are not arranged in lines, in the perpendicular direction, that is, in a column direction and, as illustrated in FIG. 2B, as an example, each of the right pixels 5BR may be arranged in a position shifted by one pixel from the corresponding one of the left pixels 5BL toward the right.

The phase difference estimation unit 10 is a processing unit that estimates, using the phase-different pixels 5B, a phase difference in a position in which an image of a subject is formed on a light receiving surface via the lens 3.

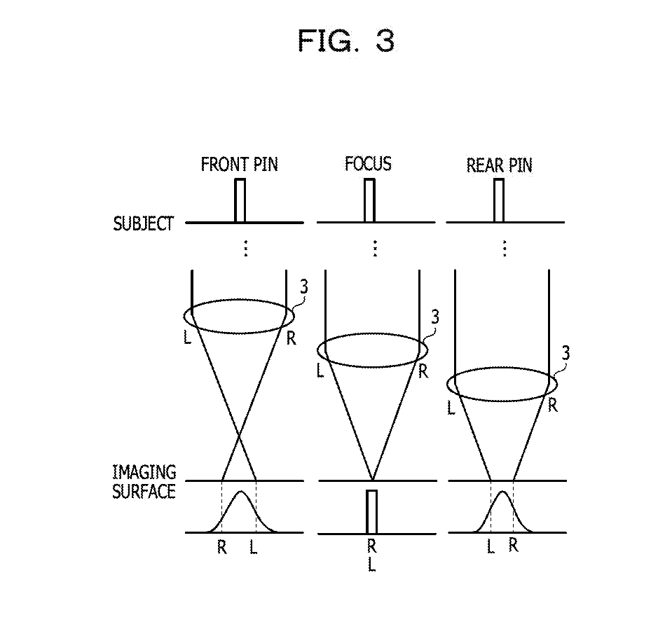

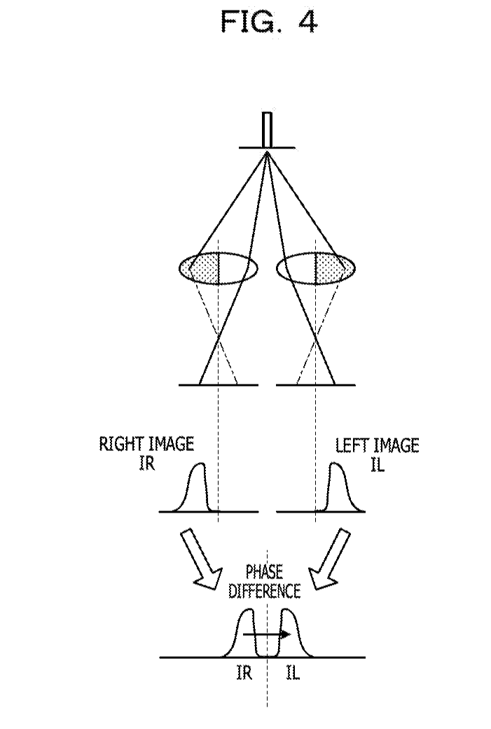

FIG. 3 is a view illustrating an example of focus. In FIG. 3, a front pin, a focus, and a rear pin are schematically illustrated. As illustrated in FIG. 3, if the lens 3 is not focused on the imaging surface of the imaging element 5, the focus position is on the front pin or the rear pin. As a result, a so-called defocus occurs in an image the pixel value of which has been read by the imaging pixel 5A. As described above, when defocus occurs, a phase difference between a right image and a left image occurs. FIG. 4 is a view illustrating an example of a phase difference. In FIG. 4, a right image IR and a left image IL when focus is on the front pin as well as a phase difference therebetween. As illustrated in FIG. 4, when focus is on the front pin, the right image IR is shifted to a position at the left of the optical axis, while the left image IL is shifted to a position at the right of the optical axis. Thus, a phase difference that occurs due to defocus is estimated by the phase difference estimation unit 10.

In this case, as for the light receiving elements, there are individual differences therebetween, and also, when electric charges are read from the light receiving elements, outputs of the light receiving elements are influenced by heat. Therefore, noise might be generated in an image that is acquired from the phase-different pixels 5B. Thus, when noise is superimposed on the phase-different pixels 5B, the left image and the right image do not match one another, and therefore, in an aspect, an error tends to occur in operation of correlation, such as SAD and the like, which is used in phase difference estimation.

In the above-described aspect, in order to address the above-described case, as the imaging device described in the above-described BACKGROUND section, and the like, if the pixel values of the left pixels 5BL or the right pixels 5BR are added together uniformly in the vertical direction (the column direction) for the plurality of left pixel allays 5BLS or the plurality of right pixel arrays 5BRS, as described above, there are cases where the accuracy of phase difference estimation is reduced. That is, in another aspect, a problem arises in which, if an edge of an image that is acquired from the phase-different pixels 5B has a gradient hat is inclined from the vertical direction, the edge is smoothed by adding outputs of the phase-different pixels 5B together in the vertical direction and, as a result, the edge gradually becomes dull.

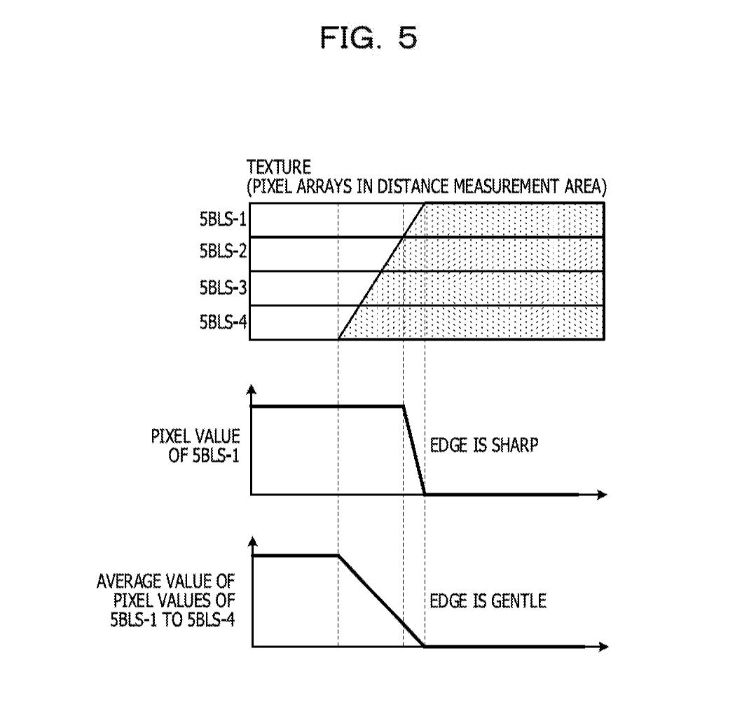

The above-described problem in the another aspect will be described below with reference to FIG. 5 to FIG. 9, in comparison between an edge when addition of pixel values in the vertical directions is performed and an edge when addition of pixel values in the vertical direction is not performed with one another.

FIG. 5 is a diagram illustrating an example of edge. FIG. 5 illustrates a case where four left pixel arrays 5BLS-1 to 5BLS-4 are included in an area of the light receiving surface of the imaging element 5 which perpendicularly intersects with the optical axis of the lens 3, which is to be focused. In an upper part of FIG. 5, for each of the left pixel arrays 5BLS-1 to 5BLS-4, the left image of the left pixel array is indicated, in a middle part of FIG. 5, the pixel value of the left pixel 5BL included in the left pixel array 5BLS-1 is indicated, and, in a lower part of FIG. 5, a representative value calculated by performing statistical processing of the pixel values of the left pixels 5BL which exist in the vertical direction, that is, in the column direction, for example, by calculating an arithmetic mean, a weighted mean, a mode value, a median value, or the like, for the four left pixel arrays 5BLS-1 to 5BLS-4, is indicated.

As indicated in the upper part of FIG. 5, an edge having an upward gradient toward the right, in other words, an edge not extending in the vertical direction, appears in the left images read by the left pixel arrays 5BLS-1 to 5BLS-4. Under the above-described imaging condition for the left images, as indicated in the middle part of the FIG. 5, when a string of pixel values of the left image read by the left pixel array 5BLS-1, which are arranged in the horizontal direction, that is, in the row direction, is extracted, a sharp edge locally appears. However, when the pixel values of the left images read by the left pixel arrays 5BLS-1 to 5BLS-4 are averaged in the perpendicular direction to the phase difference detection direction, that is, the pixel values are averaged in the vertical direction, the edge is smoothed and, as a result, the edge is dull.

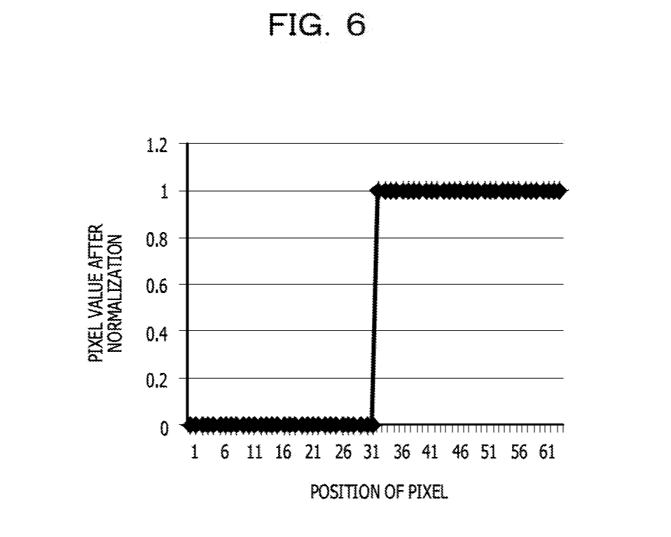

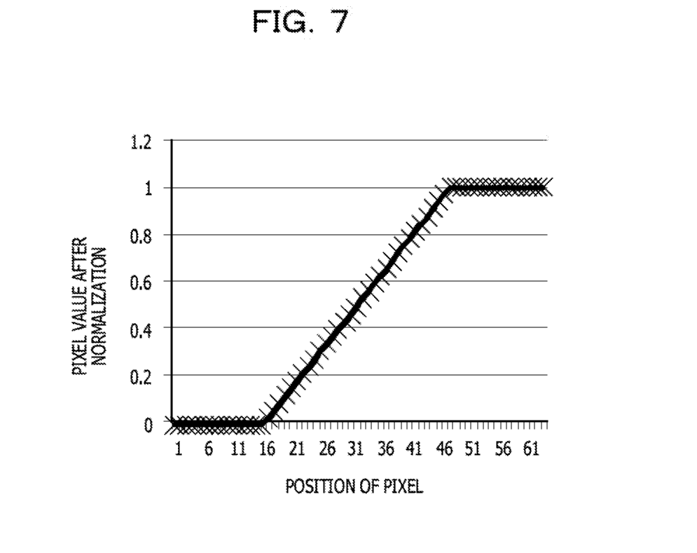

Each of FIG. 6 and FIG. 7 is a graph illustrating an example of relationship between position and pixel value for a phase-different pixel. In each of the graphs of FIG. 6 and FIG. 7, the ordinate axis indicates a normalized pixel value and, in this example, a case where original pixel values denoted by gradation values of 0 to 255 are normalized to values of 0 to 1 is illustrated. Also, in each of the graphs of FIG. 6 and FIG. 7, the abscissa axis indicates the position of the left pixel 5BL and, in this example, a case where indexes are given in order from the leftmost left pixel 5BL to the rightmost left pixel 5BL in the left pixel array 5BLS is illustrated. As for the twp graphs, in FIG. 6, the relationship between the position and the pixel value for the left pixel array 5BLS-1 indicated in the middle part of FIG. 5 is illustrated, while, in FIG. 7, a relationship between the position and the pixel value for a left image achieved by averaging the pixel values in the vertical direction for the four left pixel arrays 5BLS-1 to 5BLS-4 indicated in the lower part of FIG. 5 is illustrated.

As illustrated in FIG. 6, it is understood that, when the pixel value of the left pixel array 5BLS-1 is normalized, a more sharp edge than the edge indicated in the middle part of FIG. 5 appears. On the other hand, as illustrated in FIG. 7, it is understood that, even when an average value acquired by averaging the pixel values in the vertical direction for the left pixel arrays 5BLS-1 to 5BLS-4 is normalized, similar to the edge indicated in the lower part of FIG. 5, only an edge that gently becomes dull as appears. Thus, when the correlation with the right image that makes a pair with the left image is calculated using the left image the edge of which has become dull, an error tends to occur in operation of the correlation of SAD or the like.

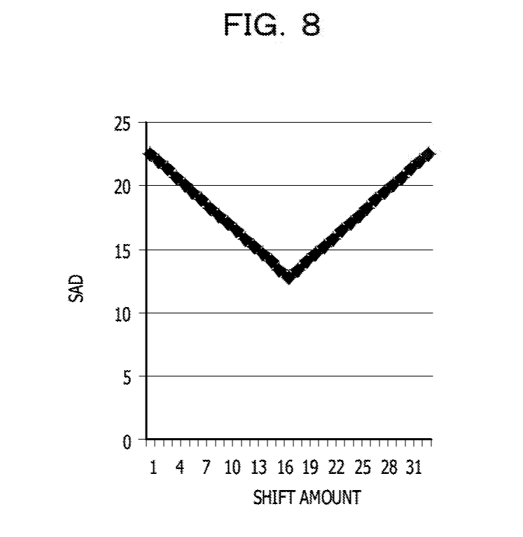

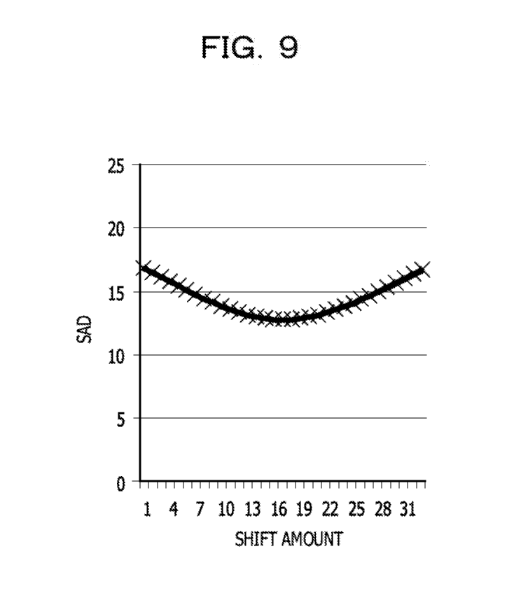

Each of FIG. 8 and FIG. 9 is a graph illustrating an example of a result of SAD calculation. In each of the graphs of FIG. 8 and FIG. 9, the ordinate axis indicates a result of SAD calculation. In each of FIG. 8 and FIG. 9 of the graphs, the abscissa axis indicates a shift amount of the right image and, in this example, the number of pixels is used as a unit. FIG. 8 illustrates an example in which, for the pixel values of the left pixels 5BL included in the left pixel array 5BLS-1 indicated in the middle part of FIG. 5, that is, the left image, the sum of absolute differences is calculated while shifting the right image of the right pixel array 5BRS-1 (not illustrated) that makes a pair with the left pixel array 5BLS-1. Also, FIG. 9 illustrates an example in which, for the average value acquired by averaging pixel values in the vertical direction for the left pixel arrays 5BLS-1 to 5BLS-4 indicated in the lower part of FIG. 5, that is, the left image representing the left pixel arrays 5BLS-1 to 5BLS-4, the sum of absolute differences is calculated while shifting the right image representing the right pixel arrays 5BRS-1 to 5BRS-4 (not illustrated) each of which makes a pair with the corresponding one of the left pixel arrays 5BLS-1 to 5BLS-4.

When addition of pixel values in the vertical direction is not performed, as illustrated in FIG. 8, a V-shape graph is achieved. In this case, the smallest value of SAD is clear, and therefore, it is understood that it is easy to discriminate a shift amount based on which it is determined that the left image and the right image match one another. On the other hand, when addition of pixel values in the vertical direction is performed, as illustrated in FIG. 9, a parabolic graph having a downwardly convex shape is achieved and, in this graph, the opening of the parabola is large due to dullness of the edge. In this case, the smallest value of SAD is not clear, and thus, it is understood that it is not easy to discriminate a shift amount based on which it is determined that the left image and the right image match one another. Therefore, when addition of pixel values in the vertical direction is performed, an error tends to occur in operation of correlation, such as SAD and the like, as compared with when addition of pixel values in the vertical direction is not performed.

The graph of FIG. 8 indicates a result of SAD calculation when noise is superimposed on the left pixel array 5BLS-1 and the right pixel array 5BRS-1. Similarly, the graph of FIG. 9 indicates a result of SAD calculation when noise is superimposed on the left pixel arrays 5BLS-1 to 5BLS-4 and the right pixel arrays 5BRS-1 to 5BRS-4. When noise is not superimposed on any pixel array, for only a single array or an average of a plurality of pixels, the shape around the smallest value of SAD is a V-shape, similar to FIG. 8, and the smallest value is 0.

Then, as one aspect, when the phase difference estimation unit 10 statistically processes pixel values in the perpendicular direction for each pair of the phase-different pixels 5B formed such that light passing ranges thereof in which incident light that enters the corresponding receiving element passes through the lens 3 are symmetrical between a plurality of strings of phase-different pixels 5B, which extend in parallel to one another, the phase difference estimation unit 10 performs the statistical processing in a direction in which an edge that appears in a distance measurement area shifts from the vertical direction. Then, the phase difference estimation unit 10 operates the correlation therebetween for each shift amount, using a string of representative values that have been acquired for each pair by the above-described statistical processing, thereby estimating, as a phase difference, a shift amount with the highest correlation has been achieved. Thus, the phase difference estimation unit 10 realizes phase difference AF processing that may reduce reduction in accuracy of phase difference estimation.

As illustrated in FIG. 1, the phase difference estimation unit 10 includes a distance measurement area setting unit 11, an acquisition unit 12, an edge detection unit 13, a correlation calculation unit 14, a direction calculation unit 15, a statistical processing unit 16, a phase difference calculation unit 17, and a defocus amount calculation unit 18.

The distance measurement area setting unit 11 is a processing unit that sets an area, that is, a so-called distance measurement area, which is to be focused.

As an embodiment, the distance measurement area setting unit 11 determines a shape, a position, and a size to set a distance measurement area. For example, when the distance measurement area setting unit 11 determines the shape of a distance measurement area, the distance measurement area setting unit 11 may employ, as the shape of the distance measurement area, an arbitrary shape, such as a polygon, an ellipse, and the like, as well as a rectangular shape. Also, when the distance measurement area setting unit 11 determines the position of a distance measurement area, the distance measurement area setting unit 11 may use, as an example, a result of face detection. For example, when central coordinates of a face area or vertex coordinates of a face area are output as a result of face detection from a face detection engine, the distance measurement area setting unit 11 may use the central coordinates or the vertex coordinates as they are, as central coordinates or vertex coordinates of a distance measurement area. As another alternative, the distance measurement area setting unit 11 may set a coordinate position designated on a live view image displayed on a touch panel (not illustrated) or the like as the central coordinates of a distance measurement area. Also, when the distance measurement area setting unit 11 determines the size of a distance measurement area, the distance measurement area setting unit 11 may employ a predetermined size as it is, and may employ a size that is determined by pinch-in or pinch-out received via a touch panel (not illustrated) or the like to automatically or manually determine the size of the distance measurement area.

In this case, the distance measurement area setting unit 11 sets, for a distance measurement area, a size of an area including at least two or more pairs of the left pixel array 5BLS and the right pixel array 5BRS in the column direction. As an embodiment, the distance measurement area setting unit 11 sets, for a distance measurement area, a size of an area including 64 pairs of the light pixel array 5BLS and the right pixel array 5BRS. In this case, the number of pairs of the left pixel array 5BLS and the right pixel array 5BRS included the measurement area in the column direction and the number of pairs of the left pixel array 5BLS and the right pixel array 5BRS included the measurement area in the row direction may be the same, and also, may be different.

The acquisition unit 12 is a processing unit that acquires a left image and a right image from the phase-different pixels 5B that make a pair.

As an embodiment, when a distance measurement area is set by the distance measurement area setting unit 11, the acquisition unit 12 acquires a left image and a right image from each of all of the phase-different pixels 5B of the left pixel allays 5BLS and the right pixel arrays 5BRS that exist in the distance measurement area. Thus, the left image and the right image that have been acquired by the acquisition unit 12 for each of the left pixel allays 5BLS and each of the right pixel arrays 5BRS are output to the edge detection unit 13.

The edge detection unit 13 is a processing unit that detects an edge of the left image or the right image.

As an embodiment, the edge detection unit 13 arranges the left images that have been acquired by the acquisition unit 12 in lines in accordance with the arrangement of the left pixel arrays 5BLS to integrate the left images. Then, the edge detection unit 13 executes edge detection by applying a filter, such as an operator, a so-called MAX-MIN filter, a Sobel filter, and the like, to an integrated left image. Thus, a gradient for pixel values in the horizontal direction and a gradient for pixel values in the perpendicular direction may be acquired from the integrated left image. Similarly, with the left images replaced with the right images and the left pixel arrays replaced with the right pixel arrays, edge detection is executed, so that a gradient for pixel values in the horizontal direction and a gradient for pixel values in the perpendicular direction may be achieved from an integrated right image.

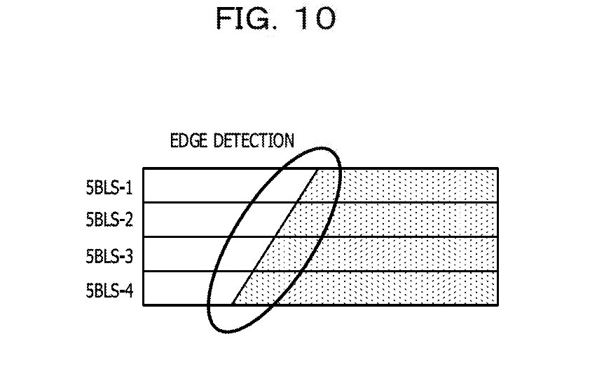

FIG. 10 is a diagram illustrating an example of edge detection. In FIG. 10, as an example, a case where four left images and four right images corresponding to four pairs of the left pixel arrays 5BLS-1 to 5BLS-4 and the right pixel arrays 5BRS-1 to 5BRS-4 are included in a distance measurement area is assumed, and furthermore, a case where edge detection is performed on the four left images is extracted therefrom and is thus illustrated. As illustrated in FIG. 10, the four left images are arranged in lines in accordance with the arrangement of the light pixel arrays 5BLS-1 to 5BLS-4. Then, as illustrated in FIG. 10, an edge having an upward gradient toward the right is detected from the left images that have been arranged in lines.

The correlation calculation unit 14 is a processing unit that calculates an edge correlation between the left images or an edge correlation between the right images.

As an embodiment, the correlation calculation unit 14 calculates an edge correlation between at least two left images among left images acquired by the acquisition unit 12. For example, while, using, as a reference, one of two left images the respective left pixel arrays 5BLS of which are arranged adjacent in the column direction, while causing the other one of the two left images to slide, the correlation calculation unit 14 calculates a correlation between two left images, for example, SAD, a correlation coefficient, and the like, for each slide amount. Similarly, with the left images replaced with the right images and the left pixel arrays replaced with the right pixel arrays, a correlation is calculated, and thereby, a correlation may be acquired for each slide amount.

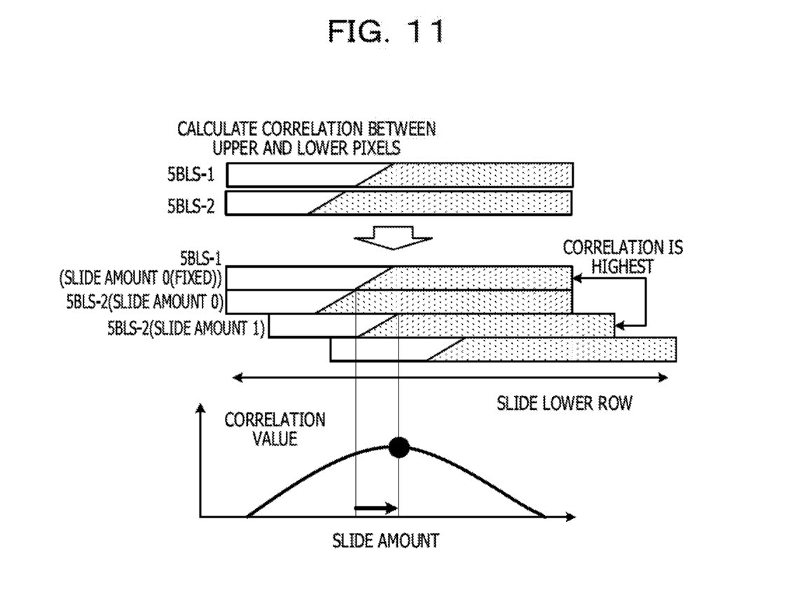

FIG. 11 is a diagram illustrating an example of a correlation calculation method. In FIG. 11, as an example, a case where four left images and four right images corresponding to the four pairs of the left pixel arrays 5BLS-1 to 5BLS-4 and the right pixel arrays 5BRS-1 to 5BRS-4 are included in a distance measurement area is assumed, and a case where a correlation between the left image of the left image array 5BLS-1 and the left image of the left pixel array 5BLS-2, among the four left images, is calculated is extracted and is thus illustrated. As illustrated in FIG. 11, in a state in which the left image of the left pixel array 5BLS-1 is fixed, the left image of the left image array 5BLS-2 is caused to slide in the row direction, that is, the direction to the left or the right. As a slide amount by which the left image of the left pixel array 5BLS-2 is caused to slide in the above-described manner, as an example, an amount corresponding to a single pixel is employed. Then, each time the left image of the left pixel array 5BLS-2 is caused to slide, a correlation coefficient is calculated for the left image of the left pixel array 5BLS-1 and the left image of the left image array 5BLS-2. In the example illustrated in FIG. 11, when the slide amount is “1”, the correlation between the left image of the left pixel array 5BLS-1 and the left image of the left pixel array 5BLS-2 is the largest.

Note that, although, in FIG. 1, a case where the imaging device 1 includes the edge detection unit 13 and the correlation calculation unit 14 is illustrated as an example, there may be a case where the imaging device 1 includes neither the edge detection unit 13 nor the correlation calculation unit 14, and also, there may be a case where the imaging device 1 includes only one of the edge detection unit 13 and the correlation calculation unit 14.

The direction calculation unit 15 is a processing unit that calculates a pixel reference direction in which, when respective representative values of pixel arrays of a plurality of different phase-different pixels are calculated, a pixel value is referred to, based on the position of an edge that appears in each pixel array. As an example, a case where the reference direction is denoted by a gradient that is inclined from the horizontal direction is illustrated as an example below.

As an embodiment, the direction calculation unit 15 calculates the above-described reference direction, using a result of edge detection in which an edge is detected by the edge detection unit 13. For example, the direction calculation unit 15 calculates a reference direction θ from a gradient of an edge in accordance with Expression 1 below. In this case, the direction calculation unit 15 may calculate a reference direction θL from a result of edge detection of the left image, may calculate a reference direction θR from a result of edge detection of the right image, and may use the two calculation results, that is, the reference direction θL and the reference direction θR, to calculate, as a reference direction θLR, an average value of the reference direction θL and the reference direction θR.

θ=tan⁻¹ (a gradient in the perpendicular direction/a gradient in the horizontal direction) Expression 1:

As another embodiment, the direction calculation unit 15 may calculate the above-described reference direction in accordance with an edge correlation between left images or the edge correlation between right images, which is calculated by the correlation calculation unit 14. In this case, as an example, the direction calculation unit 15 may calculate the reference direction θ from the slide amount with which the correlation is the largest in accordance with Expression 2 below. Note that a “row space” in Expression 2 is a space between the phase-different pixels 5B in the row direction. In this case, the direction calculation unit 15 may calculate the reference direction θL from the slide amount with which the edge correlation between left images is the largest, may calculate the reference direction θR from the slide amount with which the edge correlation between right images is the largest, and may use both of the calculation results, that is, the reference direction θL and the reference direction θR, to calculate, as the reference direction θLR, an average value of the reference direction θL and the reference direction θR.

θ=tan⁻¹ (a row space/a slide amount) Expression 2:

As still another embodiment, the direction calculation unit 15 may calculate a general reference direction θ by calculating a statistic, that is, for example, an arithmetic mean, a weighted mean, or the like, of two reference directions θ, that is, a reference direction θ calculated from a result of edge detection in which an edge is detected by the edge detection unit 13 and a reference direction θ calculated from an edge correlation calculated by the correlation calculation unit 14.

The statistical processing unit 16 is a processing unit that statistically processes a pixel value in a reference direction, which is inclined from the perpendicular direction, for each pair of phase-different pixels 5B. As a mere example, a case where the reference direction θLR is used for statistical processing is assumed below in view of uniting reference directions used for statistical processing between the left image and the right image.

As an embodiment, the statistical processing unit 16 executes statistical processing, for example, averaging processing, of pixel values of left pixels 5BL of the left pixel arrays 5BLS in the perpendicular direction to the detection direction in which a phase difference is detected, that is, in the column direction, for respective rows of the left pixel arrays 5BLS in the reference direction θLR inclined from the perpendicular direction, which has been calculated by the direction calculation unit 15. Thus, pixel values, that is, a representative left image, for one row of the representative left pixel array 7RL, which represents the plurality of left pixel arrays 5BLS included in a distance measurement area, are acquired. Similarly, by performing statistical processing with the left images replaced with the right images and the left pixel arrays replaced with the right pixel arrays, pixel values, that is, a representative right image, for one row of the representative right pixel array 7RR, which represents the plurality of the right pixel arrays 5BRS included in the distance measurement area.

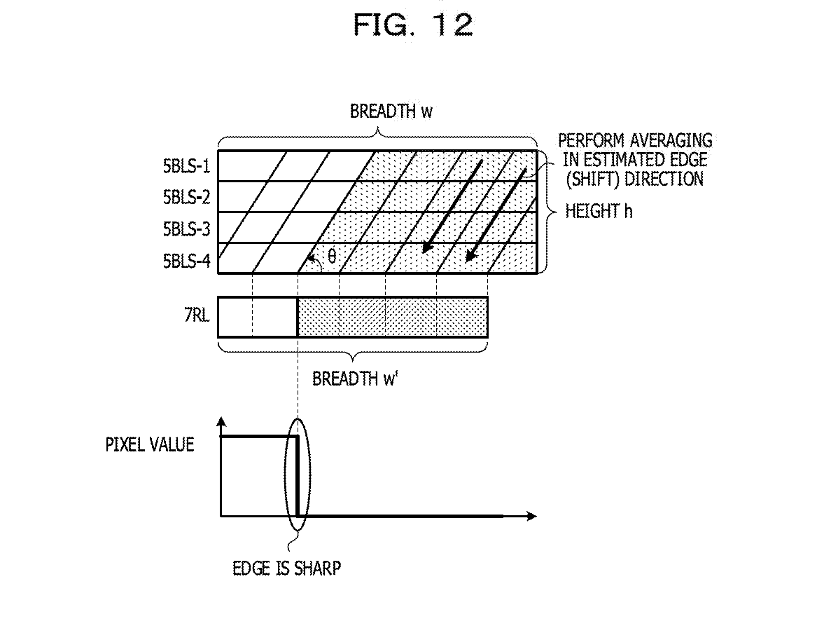

FIG. 12 is a diagram illustrating an example of statistical processing. In FIG. 12, as an example, assuming a case where four left images and four right images corresponding to four pairs of the left pixel arrays 5BLS-1 to 5BLS-4 and the right pixel arrays 5BRS-1 to 5BRS-4 are included in a distance measurement area, statistical processing is executed for the four left images. As illustrated in FIG. 12, the statistical processing unit 16 virtually sets straight lines each having a gradient that is inclined from the center of each left pixel 5BL included in the left pixel array 5BLS-1 by the same angle as that of the reference direction θLR. Then, the statistical processing unit 16 divides the total of the pixel values of ones of the left pixels 5BL of the left pixel arrays 5BLS-1 to 5BLS-4, which exist on the same straight line, by the number of rows of the left pixel arrays 5BLS-1 to 5BLS-4, that is, “4”, and thus, a pixel value (an average value) for one row of the representative left pixel array 7RL that represents the left pixel arrays 5BLS-1 to 5BLS-4 is acquired, that is, a representative left image is acquired.

In this case, the statistical processing unit 16 may remove a straight line that does not pass through all of the four rows of the left pixel arrays 5BLS-1 to 5BLS-4 from targets of statistical processing. Thus, there are cases where the representative left pixel array 7RL that includes pixels of a pixel number w′ which is smaller than a pixel number w indicating the number of pixels of the left pixel arrays 5BLS-1 to 5BLS-4 arranged in the column direction is acquired. Where the breadth and height of the distance measurement area are denoted by w and h, respectively, the pixel number w′ is expressed as in Expression 3.

w′=w−h/tan θ Expression 3:

In the representative left pixel array 7RL that is acquired in the above-described manner, pixel values of pixels over a boundary that corresponds to an edge are not smoothed by statistical processing and, as a result, the edge is maintained sharp. Note that, although an example in which statistical processing is executed on four left images has been described above, similar statistical processing is executed for four right images, and thus, a representative right image is acquired.

The phase difference calculation unit 17 is a processing unit that calculates a phase difference of the representative left image and the representative right image that make a pair.

As an embodiment, while shifting, in a state where one of the representative left image and the representative right image that have been acquired as a result of statistical processing performed by the statistical processing unit 16 is fixed, the other one of the representative left image and the representative right image, the phase difference calculation unit 17 calculates a correlation between the representative left image and the representative right image, that is, for example, the sum of absolute differences (SAD), for each shift amount. Then, the phase difference calculation unit 17 calculates, as a phase difference, a shift amount with which the smallest value of SAD that have been calculated in advance is achieved, in other words, a shift amount with which the correlation is the highest.

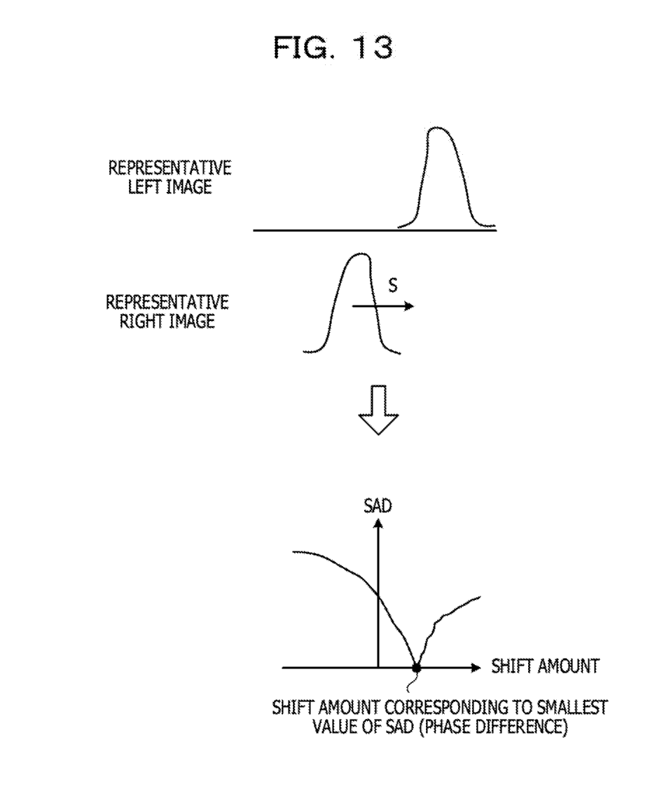

FIG. 13 is a diagram illustrating an example of an SAD calculation method. In FIG. 13, a case where, while, in a state the representative left image is fixed, the representative right image is shifted, SAD is calculated is illustrated. For example, a case where a shift amount that is calculated when the representative right image is shifted in the right direction is “positive”, and a shift amount that is calculated when the representative right image is shifted in the left direction is “negative” is assumed. In this case, as illustrated in the upper part of FIG. 13, the distribution of pixel values of the representative right image is in the left of the distribution of pixel values of the representative left image. Therefore, the example illustrated in the upper part of FIG. 13 indicates a front pin state, and it may be understood that, when the representative right image is shifted to the right, the value of SAD is increased. Then, as illustrated in the lower part of FIG. 13, a shift amount with which SAD is the smallest, that is, a shift amount with which the correlation is the highest, is derived as a phase difference.

The defocus amount calculation unit 18 is a processing unit that calculates a defocus amount.

As an embodiment, the defocus amount calculation unit 18 calculates a defocus amount from a phase difference that has been calculated by the phase difference calculation unit 17. In this case, the defocus amount calculation unit 18 may use a function used for converting the phase difference to a defocus amount, or data in which a correspondence relationship between the phase difference and the defocus amount is defined, that is, for example, a look up table. Thereafter, the defocus amount calculation unit 18 outputs the defocus amount that has been calculated in advance to the lens driving unit 3a. Thus, the lens 3 is driven in the optical direction in accordance with the defocus amount.

Note that processing units, that is, the distance measurement area setting unit 11, the acquisition unit 12, the edge detection unit 13, the correlation calculation unit 14, the direction calculation unit 15, the statistical processing unit 16, the phase difference calculation unit 17, the defocus amount calculation unit 18, and the like, which have been described above, are mounted in the following manner. For example, each of the above-described processing units is realized by causing a process that serves as a similar function to that of each of the functions of the above-described processing units to be loaded in various types of semiconductor memory elements including, for example, a random access memory (RAM), a flash memory, and the like, and causing a processing circuit, such as a central processing unit (CPU) and the like, to execute the process. There may be a case where the processing units are not realized by a CPU, and a micro processing unit (MPU) or a digital signal processor (DSP) may be caused to execute the processing units. Also, each of the above-described processing units may be realized by a hard wired logic, such as an application specific integrated circuit (ASIC), a field programmable gate array (FPGA), and the like.

[Flow of Processing]

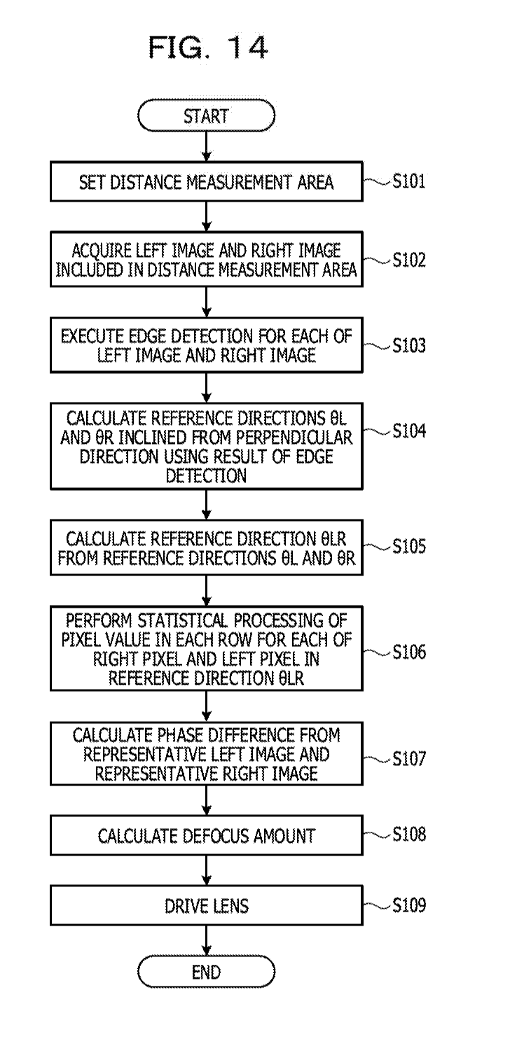

Next, a flow of processing of the imaging device 1 according to this embodiment will be described. FIG. 14 is a flow chart illustrating steps of phase difference AF processing according to the first embodiment. As an example, when a distance measurement area is set, this processing is started. Note that, as a mere example, a case where a direction shifted from the perpendicular direction is calculated in accordance with a result of edge detection will be described below.

As illustrated in FIG. 14, when a distance measurement area is set by the distance measurement area setting unit 11 (Step S101), the acquisition unit 12 acquires, among the phase-different pixels 5B included in the imaging element 5, left images and right images from all of the left pixel arrays 5BLS and the right pixel arrays 5BRS which exist in the distance measurement area (Step S102).

Subsequently, the edge detection unit 13 performs edge detection on an integrated left image acquired by arranging the left images that have been acquired in Step S102 in lines in accordance with the arrangement of the left pixel arrays 5BLS to integrate the left images, and performs edge detection on an integrated right image acquired by arranging the right images that have been acquired in Step S102 in lines in accordance with the arrangement of the right pixel arrays 5BRS to integrate the right images (Step S103).

Next, the direction calculation unit 15 calculates the reference direction θL inclined from the perpendicular direction, using a result of edge detection of the light image in Step S103, and calculates the reference direction θR inclined from the perpendicular direction, using a result of edge detection of the right image in Step S103 (Step S104).

Thereafter, the direction calculation unit 15 applies predetermined statistical processing, for example, an averaging processing, to the reference direction θL and the reference direction θR that have been calculated in Step S104, and thereby, calculates the reference direction θLR, which is a unified reference direction of the reference direction θL and the reference direction θR (Step S105).

Subsequently, the statistical processing unit 16 performs statistical processing in the reference direction θLR inclined from the perpendicular direction, which has been calculated in Step S105 such that, for respective rows of the left pixel allays 5BLS, the statistical processing unit 16 statistically processes the pixel values of the left pixels 5BL of the left pixel allay 5BLS in the perpendicular direction to the detection direction in which a phase difference is detected and, for respective rows of the right pixel arrays 5BRS, the statistical processing unit 16 statistically processes pixel values of the right pixels 5BR of the right pixel array 5BRS in the perpendicular direction to the detection direction in which a phase difference is detected (Step S106).

The above-described processing of Step S106 is executed, so that a string of pixel values of the representative left pixel array 7RL, that is, a representative left image, may be acquired and a string of pixel values of the representative right pixel array 7RR, that is, a representative right image, may be acquired.

Thereafter, the phase difference calculation unit 17 calculates a phase difference between the representative left image and the representative right image that make a pair, which have been acquired by statistical processing of Step S106 (Step S107). Subsequently, the defocus amount calculation unit 18 calculates a defocus amount from the phase difference that has been calculated in Step S107 (Step S108). Then, the lens driving unit 3a drives the lens 3 in the optical axis direction in accordance with the defocus amount that has been calculated in Step S108 (Step S109), and processing is terminated.

[One Aspect of Advantage]

As has been described above, when the phase difference estimation unit 10 according to this embodiment statistically processes pixel values in the perpendicular direction for each pair of the phase-different pixels 5B formed such that light passing ranges thereof in which incident light that enters the corresponding receiving element passes through the lens 3 are symmetrical with one another between a plurality of strings of phase-different pixels 5B, which are arranged in parallel to one another, the phase difference estimation unit 10 according to this embodiment performs statistical processing in a direction in which an edge that appears in the distance measurement area is shifted from the perpendicular direction. Then, furthermore, the phase difference estimation unit 10 operates the correlation therebetween for each shift amount, using a string of representative values that have been acquired for each pair of the phase-different pixels 5B by the above-described statistical processing, thereby estimating, as a phase difference, a shift amount with which the correlation is the highest. Thus, the phase difference estimation unit 10 may reduce reduction in accuracy of phase difference estimation.

### Second Embodiment

An embodiment related to a disclosed device has been described so far, but the present disclosure may be realized in various different embodiments, in addition to the above-described embodiment. Another embodiment of the present disclosure will be described below.

[Division of Distance Measurement Area]

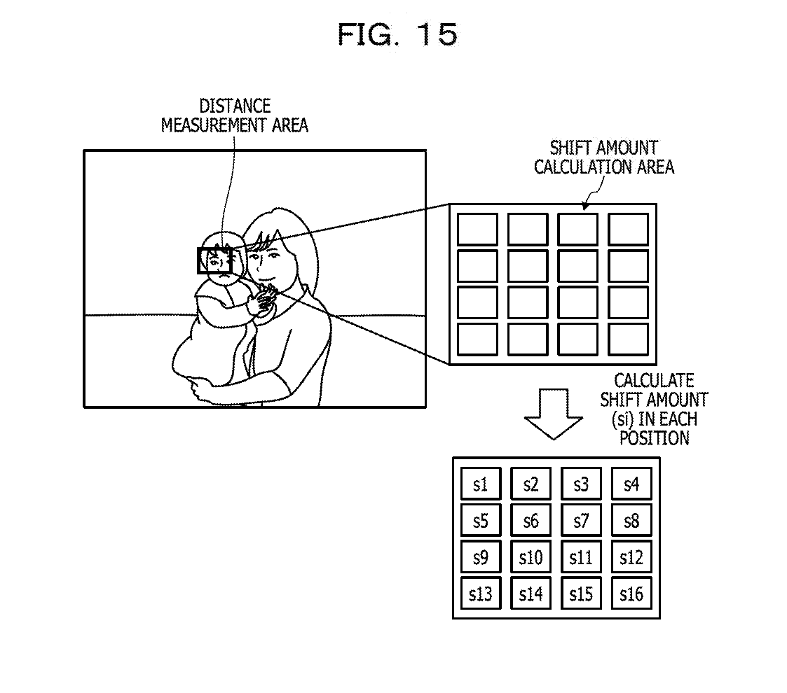

For example, the phase difference estimation unit 10 may divide a distance measurement area into a plurality of small zones, each of which is smaller than the distance measurement area. Based on an aspect in which a shift amount is calculated in each small zone, the small zone will be hereinafter referred to as a “shift amount calculation area” occasionally. FIG. 15 is a view illustrating an example of a distance measurement area dividing method. In FIG. 15, an example in which a distance measurement area is divided into 16 shift amount calculation areas is illustrated. The shift amount calculation area illustrated in FIG. 15 is set such that at least two pairs of the left pixel allays 5BLS and the right pixel arrays 5BRS are included therein. Although, in FIG. 15, a case where the shift amount calculation area is set such that the small zones do not overlap one another is illustrated as an example, the shift amount calculation area may be set such that some of the small zones overlap another one of the small zones. Thus, the processing of S102 to Step S107 illustrated in FIG. 14 is executed for each shift amount calculation area illustrated in FIG. 15, and thereby, the phase difference estimation unit 10 calculates shift amounts s1 to s16 with which the correlation is the highest. Shift amount calculation processing that is executed for each of the shift amount calculation areas may be executed for each of the shift amount calculation areas one by one in order, and may be executed for some or all of the shift amount calculation areas in parallel. Then, the phase difference estimation unit 10 calculates a representative value, that is, for example, a statistic, such as, for example, an average value, a mode value, and the like, of the shift amounts s1 to s16 to calculate a general shift amount, and thus, estimates, as a phase difference, the general shift amount that has been calculated.

In the above-described manner, a distance measurement area is divided into small zones and the shift amount is calculated for each of the small zones, so that the following advantage may be achieved. For example, even when texture shifts in a plurality of directions are included in the distance measurement area, a texture shift amount in each small zone may be reduced, and the influence of the texture shift may be reduced. Furthermore, a representative value is calculated from a plurality of shift amounts, and thereby, the influence of an error may be reduced.

[First Application Example of Division]

In the above-described Division of Distance Measurement Area section, a case where the size of each shift amount calculation area is fixed has been described as an example, but the size of the shift amount calculation area may be variably set in accordance with the texture. For example, when a gradient of the reference direction θLR that is calculated by the direction calculation unit 15 is small (relative to the horizontal direction), due to reduction in the number of pixels in the horizontal direction, that is, in the column direction, which is calculated, based on Expression 3 above, there might be a case where enough pixels for SAD calculation are not acquired, and there might be a case where the accuracy of SAD calculation is reduced. In that case, the distance measurement area may be divided into a plurality of zones in the perpendicular direction. For example, when it is assumed that breadth of the distance measurement area is denoted by w and the lower limit of the number of pixels in the horizontal direction that are to be left after statistical processing is denoted by w′, in order to satisfy an inequality of Expression 4 below, a height h′ of a shift amount calculation area after division is set, and thus, reduction in accuracy of SAD calculation may be reduced.

h′<tan θ*(w−w′) Expression 4:

[Second Application Example of Division]

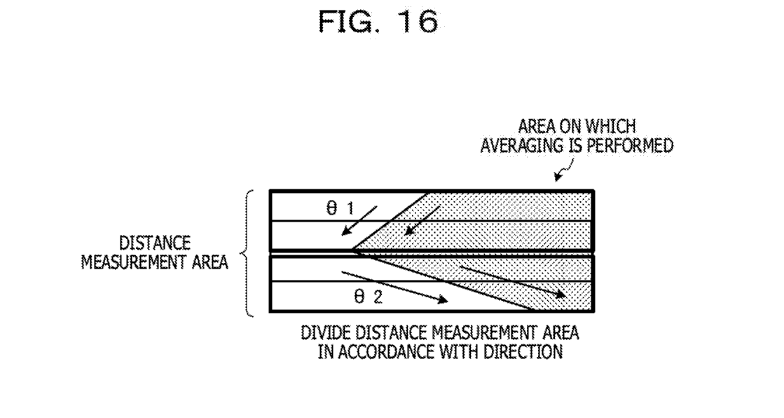

FIG. 16 is a diagram illustrating an application example of the distance measurement area dividing method. As illustrated in FIG. 16, when a plurality of reference directions θ1 and θ2 is included in a distance measurement area, that is, when a luminance gradient of the left pixel arrays 5BLS-1 to 5BLS-2 and a luminance gradient of the right pixel arrays 5BRS-3 to 5BLS-4 differ from one another, the distance measurement area may be divided for each of the reference directions θ1 and θ2. Thus, the shift amount calculation area is set in accordance with the texture and, as a result, the shift amount is calculated, while textures are not mixed and an edge is maintained.

[Application Direction of Statistical Processing]

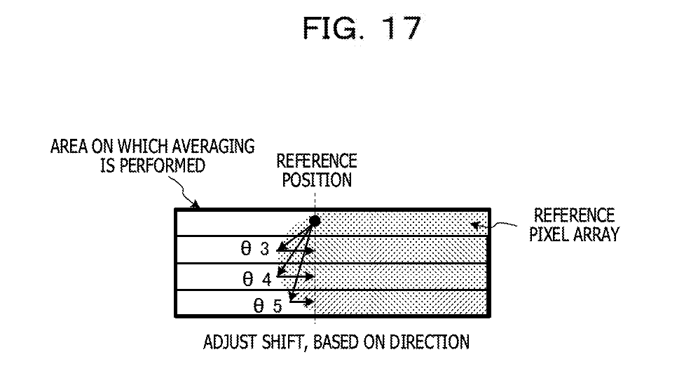

In the above-described Second Application Example of Division section, a case where a distance measurement area is divided in accordance with the reference direction θ of a texture has been described as an example, but there may be a case where a texture shift is adjusted, based on the reference direction θ, without dividing the distance measurement area. FIG. 17 is a diagram illustrating an application example of the statistical processing. As illustrated in FIG. 17, using the first left pixel array 5BLS-1 in the distance measurement area as a reference, reference directions θ3 to θ5 of respective textures of pixel arrays, that is, the left pixel arrays 5BLS-2, 5BLS-3, and 5BLS-4, are calculated. In performing the above-described statistical processing, in accordance with a reference position, to which one of the left pixels 5BL in each pixel array statistical processing is applied is determined in accordance with the reference direction of each pixel array, and thereby, even when textures in a plurality of directions are included in the distance measurement area, calculation is enabled with a sharp edge maintained.

[Evaluation of Reference Direction]

For example, the phase difference estimation unit 10 may calculate an evaluation value in accordance with the degree of pixel array match, based on a texture shift of pixel arrays in the perpendicular direction, and use a result of the calculation in determination of the reliability of an estimated shift amount. For example, as in the example illustrated in FIG. 16, when the reference directions θ in an area on which averaging is performed are equal to one another in respective pixel arrays, the edge is maintained more accurately in the average pixel array, and therefore, the accuracy of phase difference estimation is increased. On the other hand, as illustrated in FIG. 17, if there are variations in reference direction θ, pixel values are averaged, so that, presumably, original textures are mixed. In this case, the accuracy of phase difference estimation is reduced.

Accordingly, the phase difference estimation unit 10 may set an evaluation value of the estimated shift amount in accordance with the degree of reference direction θ match in the distance measurement area (or in a shift amount estimation window). For example, the phase difference estimation unit 10 sets the evaluation value such that, as a standard deviation of θ in the area reduces, the evaluation value increases. Also, a correlation value that was calculated by the correlation calculation unit 14 when the reference direction θ was calculated also indicates the degree of pixel array match, and therefore, the evaluation value may be calculated using the correlation value, instead of the above-described standard deviation.

[Combination Use with Contrast AF]

In the first embodiment described above, a case where the phase difference AF method is executed alone has been described as example, but the phase difference AF method may be executed in combination with another AF method. For example, the imaging device 1 may use the above-described phase difference AF method not only alone but also as a hybrid AF method in combination with a contrast AF method. The contrast AF method is a method in which, while moving the position of the lens 3, a position in which a contrast is the largest is searched and focus is adjusted. Each time the lens 3 is moved, contrast determination is performed, and therefore, focus may be advantageously adjusted at high accuracy, while it takes some time to detect a largest contrast, that is, it takes some time to adjust focus.

Based on the foregoing, the imaging device 1 calculates a rough focus position at high speed using phase difference AF, and moves the lens 3, based on a calculation value. Then, the imaging device 1 adjusts focus using contrast AF, while moving the position of the lens 3 little by little, and shoots an image in a position that is in focus. As described above, the lens 3 is moved by image surface phase difference AF processing and then contrast AF processing is executed, so that the number of times move of the lens 3 is tried and failed in contrast AF may be reduced and, at the same time, the accuracy of focus detection by contrast AF may be enjoyed. Thus, it is possible to accurately adjust focus at high speed.

[Phase Difference Pixel]

In the first embodiment described above, a case where, as a pair of phase-different pixels 5B, a left pixel 5BL which a light flux enters from the left side of the lens 3 and a right pixel 5BR which a light flux enters from the right side of the lens 3 are incorporated in the imaging element 5 has been described as an example, but the present disclosure is not limited thereto. For example, the imaging element 5 may be configured such that an upper pixel 5BU which a light flux enters from the upper side of the lens 3 and a lower pixel 5BD which a light flux enters from the bottom of the lens 3 are incorporated in the imaging element 5. In this case, with the left pixel array in which pixels are continuously arranged in the row direction, replaced with the upper pixel array in which pixels are continuously arranged in the column direction, and the right pixel array in which pixels are continuously arranged in the row direction, replaced with the lower pixel array in which pixels are continuously arranged in the column direction, a pair of the upper pixel array and the lower pixel array that are located adjacent one another in the row direction is included in each of two or more distance measurement areas, and thus, similar to the first embodiment, phase difference AF processing is executed.

[Disintegration and Integration]

Also, each component element of each unit illustrated in the drawings may not be physically configured as illustrated in the drawings. That is, specific embodiments of disintegration and integration of each unit are not limited to those illustrated in the drawings, and all or some of the units may be disintegrated/integrated functionally or physically in an arbitrary unit in accordance with various loads, use conditions, and the like. For example, the distance measurement area setting unit 11, the acquisition unit 12, the edge detection unit 13, the correlation calculation unit 14, the direction calculation unit 15, the statistical processing unit 16, the phase difference calculation unit 17, or the defocus amount calculation unit 18 may be coupled, as an external device, to the imaging device 1. Also, each of the distance measurement area setting unit 11, the acquisition unit 12, the edge detection unit 13, the correlation calculation unit 14, the direction calculation unit 15, the statistical processing unit 16, the phase difference calculation unit 17, and the defocus amount calculation unit 18 may be included in a corresponding one of other devices than the imaging device 1 and be coupled to the imaging device 1 to operate in cooperation, thereby realizing the functions of the imaging device 1, which have been described above.

[Phase Difference Estimation Program]

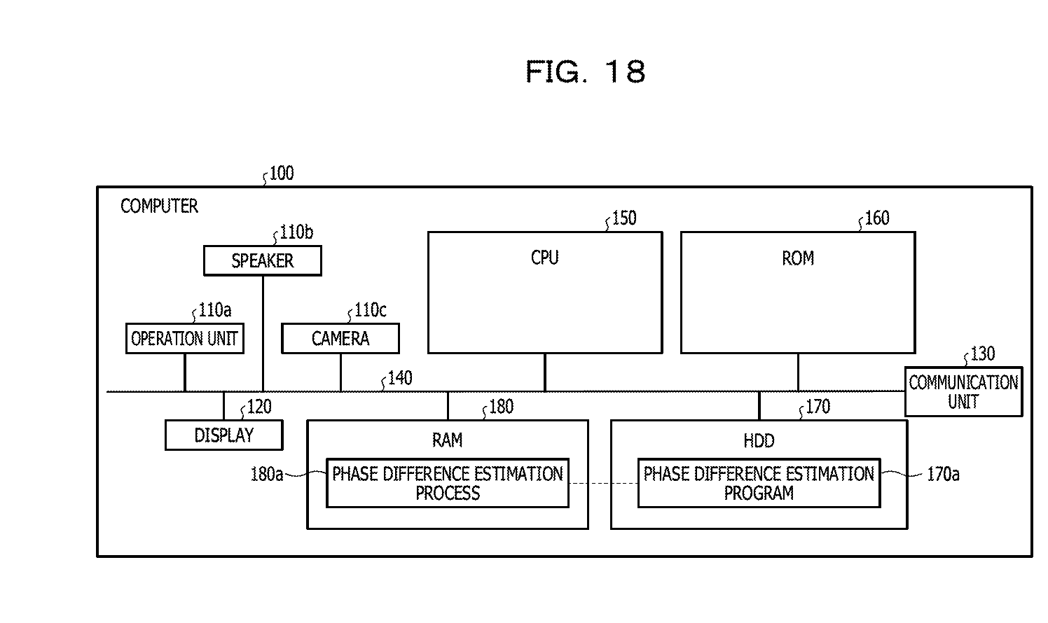

Also, various types of processing, which have been described in the above-described embodiments, are realized, for example, by causing a computer, such as a personal computer, a work station, and the like, to execute a program that has been prepared in advance. Thus, an example of a computer that executes a phase difference estimation program that has similar functions to those described in the above-described embodiments will be described below with reference to FIG. 18.

FIG. 18 is a diagram illustrating a hardware configuration example of a computer that executes a phase difference estimation program according to each of the first embodiment and the second embodiment. As illustrated in FIG. 18, a computer 100 includes an operation unit 110a, a speaker 110b, a camera 110c, a display 120, and a communication unit 130. Furthermore, the computer 100 includes a CPU 150, a ROM 160, an HDD 170, and a RAM 180. The operation unit 110a, the speaker 110b, the camera 110c, the display 120, the communication unit 130, the CPU 150, the ROM 160, the HDD 170, and the RAM 180 are coupled to one another via a bus 140.

As illustrated in FIG. 18, a phase difference estimation program 170a that has similar functions to those of the phase difference estimation unit 10 illustrated in the first embodiment is stored in the HDD 170. Similar to each component element of the phase difference estimation unit 10 illustrated in FIG. 1, the phase difference estimation program 170a may be integrated and disintegrated. That is, all pieces of data described in the first embodiment above may not be stored in the HDD 170, and data used for processing may be stored in the HDD 170.

In the above-described environment, the CPU 150 reads the phase difference estimation program 170a from the HDD 170 and loads the phase difference estimation program 170a to the RAM 180. As a result, as illustrated in FIG. 18, the phase difference estimation program 170a functions as a phase difference estimation process 180a. The phase difference estimation process 180a causes various types of data that have been read from the HDD 170 to be stored in an area of a storage area of the RAM 180, which has been allocated to the phase difference estimation process 180a, and causes various types of processing to be executed using the various types data that have been stored. For example, examples of processing that is executed by the phase difference estimation process 180a include the processing illustrated in FIG. 14 and the like. Note that, in the CPU 150, all of the processing units included in the phase difference estimation unit 10, which have been described in the first embodiment, may not be operated, and corresponding ones of the processing units, which correspond to some of the processing, which are execution targets, may be virtually realized. For example, a phase difference may be output to another device, and another processor or an external device may be cause to perform calculation of a defocus amount.

Note that the above-described phase difference estimation program 170a may not be initially stored in the HDD 170 or the ROM 160. For example, the phase difference estimation program 170a may be stored in a portable physical medium, such as a flexible disk, that is, a so-called FD, CD-ROM, DVD disk, magneto-optical disk, IC card, or the like, which is inserted in the computer 100. Then, the computer 100 may acquire the phase difference estimation program 170a from the portable physical medium and execute the phase difference estimation program 170a. Also, the phase difference estimation program 170a may be stored in another computer or a server device, coupled to the computer 100 via a public line, the Internet, a LAN, a WAN, or the like, and the computer 100 may acquire the phase difference estimation program 170a from the another computer or the server computer and execute the phase difference estimation program 170a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of estimating a phase difference, the method comprising:
setting an area that is to be focused in an imaging range of an imaging device, the imaging device including an imaging element having a plurality of pixel arrays of phase-different pixels;
first calculating, when a representative value for the plurality of pixel arrays is calculated, a pixel reference direction in which a pixel value is referred to, based on a position of an edge that appears in the plurality of pixel arrays;
executing statistical processing of the pixel value for the plurality of pixel arrays in the calculated reference direction; and
second calculating, by a processor, a phase difference using a pixel array that represents the plurality of pixel arrays that have been calculated by the statistical processing.

2. The method according to claim 1, wherein
the first calculating calculates from a gradient of the edge that appears in the plurality of pixel arrays.

3. The method according to claim 1, wherein the first calculating includes:
while one of two of the plurality of pixel arrays is shifted, calculating a correlation between the two pixel arrays for each shift amount, and
calculating the reference direction using the shift amount with which the correlation is the largest.

4. The method according to claim 1, wherein
when different reference directions are calculated by the first calculating, the executing executes the statistical processing for each of the reference directions.

5. The method according to claim 1, wherein
the imaging device includes a lens and a motor for the lens, and
the method further comprises:
driving the motor based on the phase difference calculated by the second calculating.

6. An apparatus comprising:
a memory; and
a processor coupled to the memory and configured to:
set an area that is to be focused in an imaging range of an imaging device, the imaging device including an imaging element having a plurality of pixel arrays of phase-different pixels,
calculate, when a representative value for the plurality of pixel arrays is calculated, a pixel reference direction in which a pixel value is referred to, based on a position of an edge that appears in the plurality of pixel arrays,
execute statistical processing of the pixel value for the plurality of pixel arrays in the calculated reference direction, and
calculate a phase difference using a pixel array that represents the plurality of pixel arrays that have been calculated by the statistical processing.

7. The apparatus according to claim 6, wherein the processor is configured to calculate from a gradient of the edge that appears in the plurality of pixel arrays.

8. The apparatus according to claim 6, wherein the processor is configured to:
while one of two of the plurality of pixel arrays is shifted, calculate a correlation between the two pixel arrays for each shift amount, and
calculate the reference direction using the shift amount with which the correlation is the largest.

9. The apparatus according to claim 6, wherein the processor is configured to:
when different reference directions are calculated in a calculation of the pixel reference direction, execute the statistical processing for each of the reference directions.

10. The apparatus according to claim 6, wherein the apparatus is the imaging device,
the apparatus further comprises a lens and a motor for the lens,
wherein the processor is configured to drive the motor to move the lens in a direction based on the calculated phase difference.

11. The apparatus according to claim 6, wherein
the imaging device includes a lens and a motor for the lens, and
the processor is configured to drive the motor based on the calculated phase difference.

12. A non-transitory storage medium storing a program for causing a computer to execute a process for estimating a phase difference, the process comprising:
setting an area that is to be focused in an imaging range of an imaging device, the imaging device including an imaging element having a plurality of pixel arrays of phase-different pixels;
first calculating, when a representative value for the plurality of pixel arrays is calculated, a pixel reference direction in which a pixel value is referred to, based on a position of an edge that appears in the plurality of pixel arrays;
executing statistical processing of the pixel value for the plurality of pixel arrays in the calculated reference direction; and
second calculating a phase difference using a pixel array that represents the plurality of pixel arrays that have been calculated by the statistical processing.

13. The non-transitory storage medium according to claim 12, wherein
the first calculating calculates from a gradient of the edge that appears in the plurality of pixel arrays.

14. The non-transitory storage medium according to claim 12, wherein the first calculating includes:
while one of two of the plurality of pixel arrays is shifted, calculating a correlation between the two pixel arrays for each shift amount, and
calculating the reference direction using the shift amount with which the correlation is the largest.

15. The non-transitory storage medium according to claim 12, wherein
when different reference directions are calculated by the first calculating, the executing executes the statistical processing for each of the reference directions.

16. The non-transitory storage medium according to claim 12, wherein
the imaging device includes a lens and a motor for the lens, and
the process further comprises:
driving the motor based on the phase difference calculated by the second calculating.
